(19) United States
(12) Patent Application Publication
(10) Pub. No.: US 2008/0125538 A1
(43) Pub. Date: May 29, 2008

(54) Resin composition for extrusion molding, method for producing the same, and method for molding the same

(75) Inventor: Makoto Kambe, Susono-Shi (JP)

Correspondence Address: Edwards Angell Palmer & Dodge LLP, 1875 Eye Street, NW, Washington, DC, 20006, US

(73) Assignee: Yazaki Corporation, Tokyo (JP)

(21) Appl. No.: 11/984,492

(22) Filed: Nov. 19, 2007

(30) Foreign Application Priority Data
Nov. 24, 2006 (JP) 2006-316999

(51) Int. Cl. C08L 23/12

(52) U.S. Cl. 524/582

(57) ABSTRACT

A resin composition for extrusion molding is obtained by kneading materials including a base resin material and an antioxidant in a kneading step and then making a resulting resin composition into pellets. The resin composition is made reusable by mixing the antioxidant the amount of which is at least twice as much as an amount of the antioxidant which is to be consumed in the kneading step and an extrusion-molding step.

### CROSS REFERENCE TO RELATED APPLICATIONS

This application is based on Japanese Patent Application No. 2006-316999, the contents of which are hereby incorporated by reference.

### BACKGROUND OF THE INVENTION

1. Field of the Invention

This invention relates to a resin composition for extrusion molding, a method for producing the same, and a method for molding the same.

2. Description of the Related Art

Extrusion molding is a widely used processing method suitable for manufacturing long objects such as a covered wire.

When, as an example, changing colors for resin compositions made of same resin materials, color change should be desirably made starting from light-color material and gradually advancing to dark-color material and likewise from transparent material to opaque material (see 239 page of Nonpatent Literature 1, Introduction to Polymer Processing Technology, 2nd ed. Nikkan Kogyo Shinbun (Industrial Daily News), Jan. 31, 1995).

However, this conventional approach is not sufficiently effective in eliminating or avoiding a large amount of resin that is wasted due to color changes.

When manufacturing electric wires, more particularly, electric wires for wiring harnesses for use in automobiles, the electric wires has to be provided with covering layers with a wide variety of colors. Numerous electric wires with different colors have to be manufactured in small quantities and, understandably, such a manufacturing system entails a slew of the waste resin.

Let us take a glance at FIGS. 1 and 3 to overview how the waste resin is resulted. FIGS. 1 and 3 schematically illustrate how covering layers for the electric wire are produced. A resin material is provided for an extruder 1 via a hopper 1a of the extruder 1 and the resin material is fed into a nozzle 2 via a screw 1b (not shown) while being heated, and a covered wire 5 is obtained by providing the resin material around a core wire 4 inside of a die 3. The waste resin is discharged out of the die 3 due to overflow caused by the color change.

Attempts to reuse the waste resin have not been successful thus far because molded or extruded items made of reused resin materials are, to the detriment of their mechanical capability, easy to get oxidized due to a thermal history of the reused resin materials (see Nonpatent Literature 1).

### SUMMARY OF THE INVENTION

Hence, it is an object of the present invention to provide a resin composition which allows reduction of waste resin caused by overflow upon, for example, changing colors for use in the resin composition made of the same material, method for producing thereof, and a method for extrusion molding that can reduce the waste resin caused for example by color change for resin compositions made of the same material.

In order to attain the above objective, the present invention is to provide the resin composition for extrusion molding which is obtained by kneading materials including a base resin material and an antioxidant in a kneading step and then making a resulting resin composition into pellets, wherein the antioxidant to be added is at least twice as much as the antioxidant which is consumed in the kneading and extrusion molding.

Also, the method for producing the resin composition for extrusion molding of this invention is a method for producing a resin composition which is obtained by kneading materials including a base resin material and an antioxidant and then making a resulting resin composition into pellets. The antioxidant to be mixed is at least twice as much as the antioxidant which is consumed in kneading and extrusion molding.

Further, the method for molding a resin composition for extrusion molding of this invention is a method for molding the resin composition for the extrusion molding comprising the step of feeding the resin composition into an extruder in order to produce an extruded product. The resin composition is obtained by kneading materials including a base resin material and an antioxidant and making a resulting resin composition into pellets. An amount of the antioxidant which is kneaded is at least as much as an amount of the antioxidant which is consumed during kneading and extrusion molding. Also, a remaining resin composition which was not used in the extruded product is recovered from the extruder, kneaded, and made into reusable pellets in order, for example, to prepare for the extrusion molding, change the materials used in the extrusion, or start extrusion-molding other products. Further, the reusable pellets are fed into the extruder as the resin composition for the extrusion molding.

According to the resin composition for extrusion molding of this invention, the amount of the antioxidant which is added is at least twice as much as that of the antioxidant which is consumed in the kneading step and the extrusion-molding step. This allows the extruded product using the reusable pellets made of the remaining resin composition to be sufficiently protected against oxidation. Accordingly, nondefective products can be manufactured without degradation of required mechanical characteristics, even when the waste resin, i.e., the remaining resin recovered from the extruder due to, for example, color change can be used as a reusable resin composition, and the remaining resin composition that has been recovered is kneaded and made into reusable pellets for another round of the extrusion molding with a desired colorant such as dye and pigment added. This also reduces raw material costs and a cost incurred by the disposal of the waste resin. Furthermore, this will also contribute to reduction of green house gas, i.e., carbon dioxide, an undesirable by-product of the disposal of the waste resin.

These and other objects, features, and advantages of the present invention will become more apparent upon reading of the following detailed description along with the accompanied drawings.

### BRIEF DESCRIPTION OF THE DRAWINGS

FIG. 1 schematically illustrates how a covered wire is manufactured using a method for extrusion molding of this invention.

FIG. 2 shows ratios of melt flow rate (MFR) change that have been observed when five rounds of kneading and extrusion-molding steps were performed for resin compositions with different amounts of antioxidant mixed.

FIG. 3 schematically illustrates how the covered wire is manufactured using the method for extrusion molding of this invention.

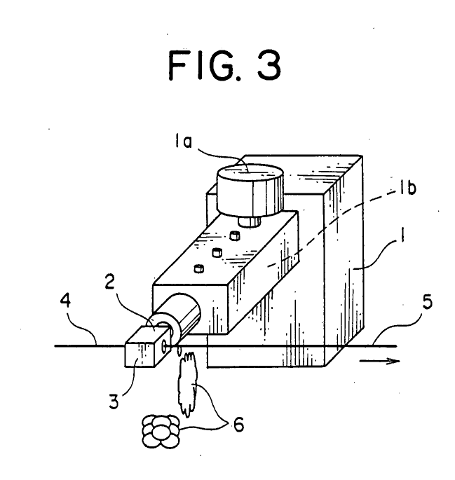

### DESCRIPTION OF THE PREFERRED EMBODIMENTS

An embodiment of the method for extrusion molding of the present invention is described with reference to the attached drawings 1 to 3.

A method for extrusion molding according to the present invention requires that an amount of an antioxidant to be mixed be at least twice as much as an amount of the antioxidant which is consumed in the course of a kneading step and an extrusion-molding step. How to determine the amount of the antioxidant to be consumed during the kneading and extrusion-molding steps can be summarized as follows:
(a) Knead materials including a base resin material and different amounts of the antioxidant.
(b) Make a resulting resin composition into pellets.
(c) Feed the pellets of the resin composition into an extruder.
(d) Let the resin composition overflow from a die.
(e) Obtain an overflow resin discharged from the die as a sample for use in evaluating a melt flow rate (MFR).
(f) Determine a minimum amount of the antioxidant where a rate of change of MFR, i.e., a ratio of the MFR value of the above overflow samples to the MFR value of the original resin before kneading, falls within the range between plus five percent and minus five percent.

Thus, the resulting minimum amount of the antioxidant to be mixed is assumed as the amount of the antioxidant consumed in the course of the kneading and extrusion-molding steps. The above procedure is repeated for a required number of times to obtain the resin composition samples including different amounts of the antioxidant.

Since a larger amount of the antioxidant to be kneaded corresponds to a larger value of the melt flow rate, an upper limit of the amount of the antioxidant to be kneaded has to be set so that the amount of the antioxidant remains within an operationally meaningful range of the MFR value in view of extrusion-molding process. In normal cases, the upper limit should be five to ten times the amount consumed during the kneading step and the extrusion-molding step, depending upon types of the resin compositions.

An antioxidant generally used in making resin compositions can be used in the method for extrusion molding of this invention without additional processing. For example, Irganox 1010, Irganox 1076, Irganox 1330, Irganox 3114 of Ciba Specialty Chemicals Inc., Adekastab A0-80, and Adekastab A0-412S of Asahi Denka Co., Ltd. can be used, from among which one or more antioxidants are chosen and mixed taking compatibility with the base resin material, retention and fluidity into consideration.

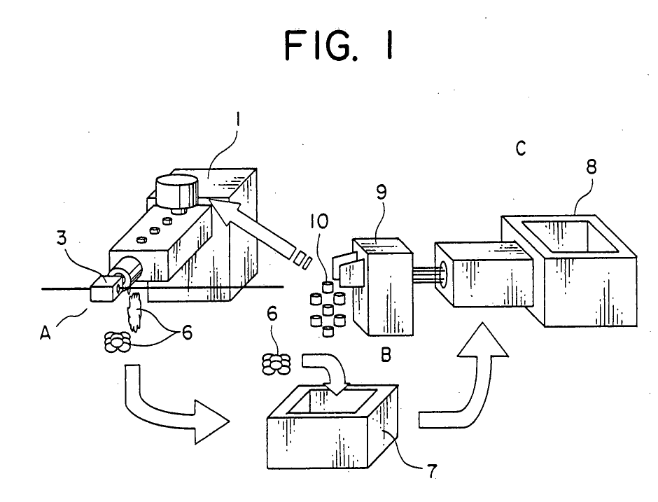

FIG. 1 illustrates how the covered wire is manufactured using the method for extrusion molding contemplated by this invention.

A resin composition for the extrusion molding is kneaded and made into pellets with a desired shape and properties, and then fed into a hopper of an extruder 1 and is extruded around the core wire introduced into a die 3 and thus a covered wire is obtained. The above resin composition includes the antioxidant at least twice as much as that consumed in the kneading step and the extrusion-molding step.

In order, for example, to prepare for the extrusion molding, change the materials used in the extrusion, or start extrusion-molding other extruded products, an idly extruded resin which was not used in an extruded product is recovered from the extruder 1 and is put into a kneader 7 so that the recovered resin composition is kneaded to be uniform. The antioxidant can be added so that the amount of the antioxidant kneaded is kept at least twice as much as the amount of the antioxidant consumed during the kneading and the extrusion molding. Also, a coloring material such as dye and pigment can be added.

Next, a resulting resin composition described above is fed into and extruded from an extruder 8 in an elongated shape, cut in an appropriate length by a cutter 9, and thus reusable resin composition pellets are obtained. In this manner, the reusable pellets made of the remaining resin composition is used alone or kneaded with pellets made of fresh resin compositions and is fed into the hopper of the extruder 1 and extruded around a core wire which is introduced into the die 3 and thus a covered wire is manufactured.

In evaluation of performance of the resin composition of this embodiment, a polypropylene-based resin composition for wire coating was used. 75 pts.wt. of the block-copolymer-type E-150GK (Primepolymer Co., Ltd.) as a polypropylene, 25 pts.wt. of R110E (Primepolymer Co., Ltd.) as an olefinic thermoplastic elastomer (TPO), 50 pts.wt. of KISUMA 5 (Kyowa Chemical Industry Co., Ltd.) as a flame retardant were respectively used. On the basis of this proportion, the resin compositions kneaded with 1, 1.5, 2, 2.5, 3, 5, and 10 pts.wt. of antioxidant Irganox 1010 (Ciba Specialty Chemicals Inc.) were evaluated. The resin composition with no antioxidant was also evaluated.

First, the amounts of the antioxidant that is consumed in the course of the kneading and extrusion-molding steps have been checked with respect to these resin compositions. The result was 1.5 pts.wt.

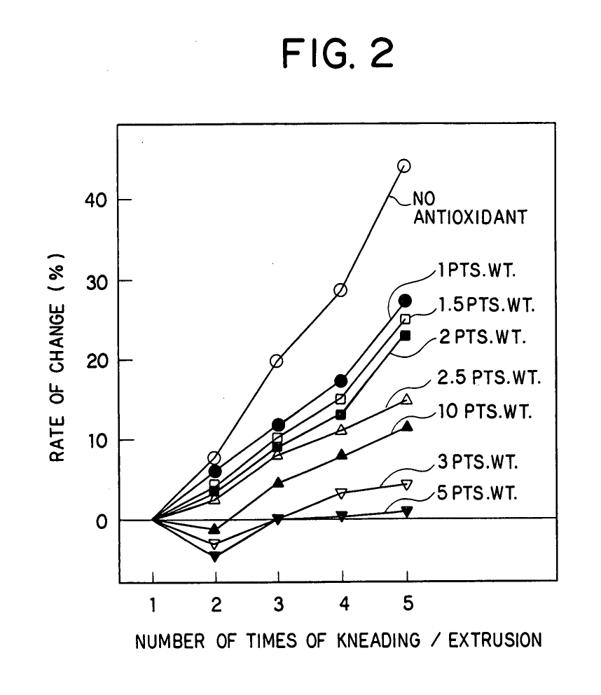

Next, rates in percentage of change in the MFR value when five rounds of kneading and extrusion-molding steps were performed was evaluated for these resin compositions, with the MFR of the resin composition immediately after preparation assumed as 100. The results are shown in FIG. 2, where pts.wt. is a unit for the amount of the antioxidant which is added.

Referring to FIG. 2, when the range of the amounts of the antioxidant to be added is within the range of zero to five pts.wt., larger amount of the antioxidant to be added leads to smaller rate of MFR change. In addition, given the larger amount of the antioxidant to be added in this range, the repeated steps of the kneading and extrusion molding affect the MFR value less significantly. Incidentally, one round of the kneading and the extruding steps includes one each of the kneading and extruding steps to be performed.

When a resin composition type that includes 3 pts.wt. of the antioxidant, which is twice as much as the amount of the antioxidant consumed during the kneading and extrusion-molding steps (1.5 pts.wt.), is used, the MFR value does not get larger even when two rounds of the kneading and extrusion-molding steps have been performed. This sharply differs from phenomena of the resin composition types that only include 2.5 pts.wt. or less of the antioxidant. The resin composition type including 5 pts.wt. or 10 pts.wt. of the antioxidant also shows similar tendency.

Note that, however, the value of MFR becomes too large for the resin composition to bemused in the extrusion-molding process for the wire coatings when 10 pts.wt. of the antioxidant is added. The resin composition of this type, therefore, does not have a practical use.

The resin compositions which were prepared by adding either 3 pts.wt. or 5 pts.wt. of the antioxidant, and went thorough one round of the kneading and extrusion-molding steps were employed in the evaluation, being assumed as the resin composition discharged from the die due to an overflow caused by a color or product change. The above discharged resin composition was kneaded and made into reusable pellets and the covered wire was manufactured. By the evaluation, it has been verified that there were not defects such as discoloration found on a surface of the product by visual observation. It has also been confirmed that the characteristics required for the wire coatings such as tensile strength and tensile elongation are not degraded when compared with a wire coating produced using a fresh resin composition including 1.5 pts.wt. of the antioxidant.

What is claimed is:

1. A resin composition for extrusion molding produced by kneading materials including a base resin material and an antioxidant and making a resulting resin composition into pellets, an amount of said antioxidant kneaded being at least twice as much as an amount of said antioxidant consumed during kneading and extrusion molding.

2. A method for producing a resin composition for extrusion molding, comprising the steps of:
kneading materials including a base resin material and an antioxidant; and
making a resulting resin composition into pellets, an amount of said antioxidant kneaded being at least twice as much as an amount of said antioxidant consumed during kneading and extrusion molding.

3. A method for molding a resin composition for extrusion molding, comprising the step of feeding the resin composition into an extruder in order to produce an extruded product, said resin composition being obtained by kneading materials including a base resin material and an antioxidant and making a resulting resin composition into pellets, an amount of said antioxidant kneaded being at least as much as an amount of said antioxidant consumed during kneading and extrusion molding, wherein a remaining resin composition recovered from the extruder is kneaded and then made into reusable pellets, said reusable pellets being fed into the extruder as the resin composition for the extrusion molding.
